(19) United States
(12) Patent Application Publication
(10) Pub. No.: US 2026/0051511 A1
(43) Pub. Date: Feb. 19, 2026

(54) CATHODE-SOLID ELECTROLYTE MULTILAYER STRUCTURE, METHOD OF MANUFACTURING THE SAME AND ALL-SOLID LITHIUM SECONDARY BATTERY INCLUDING THE SAME

(71) Applicant: SK On Co., Ltd., Seoul (KR)

(72) Inventors: Min Kyu KIM, Daejeon (KR); Kyeong Joon KIM, Daejeon (KR); Eun Jeong YI, Daejeon (KR)

(21) Appl. No.: 19/296,944

(22) Filed: Aug. 12, 2025

(30) Foreign Application Priority Data
Aug. 19, 2024 (KR) 10-2024-0110313

(51) Int. Cl. H01M 4/62; H01M 4/02; H01M 4/04; H01M 4/131; H01M 4/1391; H01M 4/36; H01M 10/052

(52) U.S. Cl. CPC H01M 4/628; H01M 4/0433; H01M 4/0471; H01M 4/131; H01M 4/1391; H01M 4/366; H01M 10/052; H01M 2004/021; H01M 2004/028

(57) ABSTRACT

A cathode-solid electrolyte multilayer structure includes a cathode layer including a cathode active material, an oxide-based solid electrolyte layer formed on the cathode layer and including oxide particles, and a mixed layer formed between the cathode layer and the oxide-based solid electrolyte layer and including the cathode active material and the oxide particles. The cathode active material and the oxide particles are in contact with each other in the mixed layer.

### CROSS-REFERENCE TO RELATED APPLICATION(S)

This patent document claims the priority and benefits of Korean Patent Application No. 10-2024-0110313 filed on Aug. 19, 2024, the disclosure of which is incorporated herein by reference in its entirety.

### TECHNICAL FIELD

The disclosure and implementations disclosed in this patent document generally relate to a cathode-solid electrolyte multilayer structure, a method of manufacturing the same, and an all-solid lithium secondary battery including the same.

### BACKGROUND

Recently, as interest in environmental issues has increased, exhaust gases emitted from vehicles powered by fossil fuels such as gasoline or diesel have been identified as one of the main causes of air pollution, and research into electric vehicles (EVs), hybrid electric vehicles (HEVs) and the like is being conducted as a means to replace such vehicles. In addition, lithium secondary batteries with high discharge voltage and output stability are mainly used as power sources for such electric vehicles (EVs), hybrid electric vehicles (HEVs) and the like.

Meanwhile, existing lithium secondary batteries that use liquid electrolytes such as organic solvents have the risk of ignition due to leakage of the liquid electrolyte, and there are problems such as the electrolyte being decomposed by electrode reactions and the battery expanding. In addition, there is a limit to securing high energy density of the battery due to the separator included in existing lithium secondary batteries to prevent these problems. Accordingly, research and development on all-solid lithium secondary batteries that use solid electrolytes are being actively conducted recently to solve the above problems.

Solid electrolytes applied to all-solid lithium secondary batteries are mainly classified into sulfide-based, polymer-based, oxide-based solid electrolytes, and the like, and thereamong, oxide-based solid electrolytes are attracting attention as next-generation solid electrolyte materials due to excellent chemical/thermal stability and mechanical strength and the like.

All-solid lithium secondary batteries with oxide-based solid electrolytes applied thereto are manufactured by applying electrolyte slurry on the electrodes and then sintering the same to form oxide-based solid electrolytes. However, there is a problem that the electrodes are damaged during the sintering process of the electrolyte slurry, which reduces the performance of the all-solid lithium secondary battery.

### SUMMARY

The present disclosure can be implemented in some embodiments to provide a cathode-solid electrolyte multilayer structure including a mixed layer formed between a cathode layer and an oxide-based solid electrolyte layer.

An aspect of the present disclosure is to provide a method of manufacturing a cathode-solid electrolyte multilayer structure, in which damage to the cathode layer may be prevented by flash light sintering a molded body including oxide particles on the cathode layer to form an oxide-based solid electrolyte.

An aspect of the present disclosure is to provide an all-solid lithium secondary battery including the cathode-solid electrolyte multilayer structure, in which interfacial resistance between the mixed layer and the oxide-based solid electrolyte layer is reduced.

In some embodiments, a cathode-solid electrolyte multilayer structure includes a cathode layer including a cathode active material; an oxide-based solid electrolyte layer formed on the cathode layer and including oxide particles; and a mixed layer formed between the cathode layer and the oxide-based solid electrolyte layer and including the cathode active material and the oxide particles. The cathode active material and the oxide particles are in contact with each other in the mixed layer.

The cathode active material and the oxide particles may be in surface contact with each other in the mixed layer.

The mixed layer may have a thickness of 0.1 to 10 μm.

The cathode layer may have a thickness of 1 to 100 μm.

A sum of thicknesses of the mixed layer and the cathode layer may be 1.1 to 110 μm.

A thickness ratio of the mixed layer and the cathode layer may be 1:100 to 1:10.

The oxide particles may have an average particle size of 0.1 to 10 μm.

The cathode active material may have an average particle size of 0.1 to 20 μm.

The mixed layer may further include colored-oxide particles.

The colored-oxide particles may have an average particle size of 1 μm or less.

The colored-oxide particles may absorb light energy in the visible light range.

In some embodiments, an all-solid lithium secondary battery includes a cathode including a cathode active material-containing cathode layer; an oxide-based solid electrolyte layer formed on the cathode and including oxide particles; a mixed layer formed between the cathode and the oxide-based solid electrolyte layer and including the cathode active material and the oxide particles; and an anode formed on the oxide-based solid electrolyte layer. The cathode active material and the oxide particles are in contact with each other in the mixed layer.

The cathode active material and the oxide particles may be in surface contact with each other in the mixed layer.

The mixed layer may have a thickness of 0.1 to 10 μm.

The cathode layer may have a thickness of 1 to 100 μm.

A sum of thicknesses of the mixed layer and the cathode may be 1.1 to 110 μm.

The mixed layer may further include colored-oxide particles.

The colored-oxide particles may have an average particle size of 1 μm or less.

In some embodiments, a method of manufacturing a cathode-solid electrolyte multilayer structure includes manufacturing a cathode layer including a cathode active material; applying an electrolyte slurry including oxide particles onto the cathode layer and then drying the electrolyte slurry, and manufacturing a molded body; and flash light sintering the molded body and forming an oxide-based solid electrolyte layer. In the flash light sintering the molded body and forming the oxide-based solid electrolyte layer, a mixed layer including the cathode active material and the oxide particles in contact with each other is formed between the cathode layer and the oxide-based solid electrolyte layer.

The electrolyte slurry may further include colored-oxide particles, and in the flash light sintering the molded body and forming the oxide-based solid electrolyte layer, the colored-oxide particles may be included in the mixed layer.

### BRIEF DESCRIPTION OF DRAWINGS

Certain aspects, features, and advantages of the present disclosure are illustrated by the following detailed description with reference to the accompanying drawings.

FIG. 1 is a schematic diagram illustrating an example of point contact, and FIG. 2 is a schematic diagram illustrating an example of surface contact.

FIG. 3 is a diagram illustrating a cathode-solid electrolyte multilayer structure according to an embodiment.

FIG. 4 is image illustrating an SEM image of a cross-section of a cathode-oxide-based solid electrolyte multilayer structure of Example 1 and an image illustrating the elemental distribution of La, Mn, and Zr.

FIG. 5 is a graph illustrating the interfacial resistance between the mixed layer and the cathode of Example 1 and Comparative Example 1.

### DETAILED DESCRIPTION

Features of the present disclosure disclosed in this patent document are described by example embodiments with reference to the accompanying drawings.

Hereinafter, various embodiments according to the present disclosure will be described, but the embodiments may be modified in various other forms, and the scope thereof is not limited to the embodiments described below.

Hereinafter, unless otherwise specifically defined in the present disclosure, when a part such as a layer, film, thin film, region, or plate is said to be “on,” “over,” or “above” another part, this may include not only a case in which it is “directly over” another part, but also a case in which there is another part therebetween.

A method of manufacturing a cathode-solid electrolyte multilayer structure according to an embodiment is described.

A method of manufacturing the cathode-solid electrolyte structure may include an operation of manufacturing a cathode layer, an operation of applying an electrolyte slurry including oxide particles on the cathode layer and then drying the electrolyte slurry to manufacture a molded body, and an operation of flash light sintering the molded body to form an oxide-based solid electrolyte layer on the cathode layer.

First, the cathode layer may be manufactured by applying a cathode slurry including a cathode active material on a cathode current collector, and then drying the cathode slurry, and forming a cathode mixture layer.

The cathode active material may be suitably used in the present disclosure as long as it is a lithium transition metal oxide capable of absorbing and releasing lithium ions, which may be commonly used as a cathode active material in a secondary battery, and examples thereof may include NCM-based, NCA-based or NCMA-based lithium composite oxides, lithium composite oxides of manganese and nickel such as LiMn_{1.5}Ni_{1.5}O₄, lithium titanate, lithium cobaltate, lithium nickelate, lithium manganese, titanium oxide, niobium oxide, tungsten oxide, molybdenum oxide, and lithium metal phosphate such as LiMPO₄ (M═Fe, Mn, Co, Ni), Li₃V₂ (PO₄)₃.

In detail, the cathode active material may be LiₐNiₓM₁₋ₓO_{2+y}(0.9≤a≤1.2, 0.5≤x≤0.99, −0.1≤y≤0.1). M may represent at least one element selected from Na, Mg, Ca, Y, Ti, Zr, Hf, V, Nb, Ta, Cr, Mo, W, Mn, Co, Fe, Cu, Ag, Zn, B, Al, Ga, C, Si, Sn, Ba or Sr. In this case, in detail, 0.95 a 1.08 may be satisfied, and x may be 0.6 or more, 0.8 or more, greater than 0.8, 0.9 or more, or 0.98 or more. In addition, in detail, M may include Co, Mn, or Al, and in more detail, include Co and Mn, and may further include Al as needed.

In more detail, the cathode active material may be an NCM-based cathode active material represented by Liₐ (NiₓCo_{y}Mn_{z}) O₂ (0.9≤a≤1.2, 0≤x≤0.99, 0≤y≤0.5, 0≤z≤0.5, x+y+z=1), an NCMA-based cathode active material further including Al in addition thereto, or an NCA-based cathode active material represented by Liₐ(NiₓCo_{y}Al_{z})O₂(0.9≤a≤1.2, 0≤x≤0.99, 0≤y≤0.5, 0≤z≤0.5, x+y+z=1). In this case, 0.95≤a≤1.08 may be satisfied, and x may be 0.6 or more, 0.8 or more, 0.9 or more, or 0.98 or more.

In addition, the cathode active material may be LLO (Li rich layered oxides, Over Lithiated Oxides, Over-lithiated layered oxide, OLO, LLOs) represented by Li₁₊ₓM₁₋ₓO₂, and in this case, 0≤x≤0.4 may be satisfied, and M may include at least one element among Na, Mg, Ca, Y, Ti, Zr, Hf, V, Nb, Ta, Cr, Mo, W, Ni, Mn, Co, Fe, Cu, Ag, Zn, B, Al, Ga, C, Si, Sn, Ba and Sr, and in detail, may include Ni, Co, Mn, or Al, and in more detail, may include Ni, Co and Mn, and may further include Al as needed.

In some example embodiments, the cathode active material may further include doping or coating on a surface.

For example, the doping or coating may include Al, Ti, Ba, Zr, Si, B, Mg, P, W, Na, V, Cu, Zn, Ge, Ag, Ba, Nb, Ga, Cr, Sr, Y, Mo or alloys thereof or oxides thereof, and these may be used alone or in combination of two or more. The cathode active material may be passivated by the doping or coating, so that the penetration stability and lifespan may be further improved.

For example, the lithium transition metal oxide may be in the form of a secondary particle formed by densely packing primary particles.

In addition, the lithium transition metal oxide may be a secondary particle formed by assembling or agglomerating a plurality of primary particles to form a substantially single particle, or may be in the form of a single particle.

The single particle form may mean, for example, excluding a secondary particle formed by assembling or agglomerating a plurality of primary particles (for example, more than 10) to form a substantially single particle. However, the single particle form does not exclude that 2 to 10 single particles are attached or adhered to each other to form a single body.

In some embodiments, the cathode active material may include both a secondary particle form and single particle form.

When the lithium transition metal oxide includes a lithium transition metal oxide particle in single particle form, cracks in the particle may be reduced during charging and discharging of the secondary battery, and the BET surface area that reacts with the electrolyte may be reduced, thereby reducing the side reaction between the electrolyte and the cathode active material. Accordingly, the life characteristics of the secondary battery and the capacity retention rate during repeated charging and discharging may be further improved.

In an embodiment, the cathode active material may be included in an amount of about 20 to about 90 wt % based on the solid weight of the cathode slurry.

In an embodiment, the cathode active material may have an average particle size of about 0.1 to about 20 μm.

If the cathode active material has an average particle size outside the above-described range, it may be difficult for the cathode active material and the oxide particles to contact each other in the mixed layer described below.

Accordingly, the interfacial resistance between the mixed layer and the cathode layer may increase. The content of the cathode active material and the oxide particles contacting each other in the mixed layer and the interfacial resistance between the mixed layer and the cathode layer will be described in detail later.

The cathode slurry may further include a conductive material. The conductive material is not particularly limited, but any material that may remain during the sintering process may be suitably used, and for example, at least one kind of carbon-based conductive material selected from the group consisting of natural graphite, artificial graphite, expanded graphite, carbon black, acetylene black, Ketjen black, channel black, furnace black, lamp black, thermal black, carbon fiber, fluorinated carbon, graphene, carbon nano-fiber, graphitized carbon flake, carbon tube, carbon nanotube, and activated carbon may be used.

In addition, as the conductive material, metal-based conductive materials, for example, metal powders such as copper, nickel, aluminum, indium, tin and silver, and metal fibers may be used. In detail, at least one kind of metal oxide-based conductive material selected from the group consisting of indium tin oxide (ITO), indium zinc oxide (IZO), antimony tin oxide (ATO), fluoride tin oxide (FTO), aluminum zinc oxide (AZO), magnesium indium oxide (MIO), zinc gallium oxide (GZO), gallium indium oxide (GIO), indium-gallium-zinc oxide (IGZO), Niobium Strontium Titanium Oxide (Nb-STO), Indium Cadmium Oxide (ICO), Boron Zinc Oxide (BZO), SiO₂—ZnO (SZO) and Indium Oxide (In₂O₃) may be used.

In an embodiment, the conductive material may be included in an amount of about 0.1 to about 15 wt % based on the solid content weight of the cathode slurry.

In addition, the cathode slurry may further include a binder. The binder may be at least one selected from the group consisting of acrylic resin, polyvinylidene fluoride-hexafluoropropylene copolymer (PVdF-co-HFP), polyvinylidene fluoride (PVdF), polyacrylonitrile, polyacrylic acid, sodium polyacrylate, polyimide, polymethylmethacrylate, styrene-butadiene rubber (SBR), acrylated styrene-butadiene rubber, polyvinyl alcohol, polyvinyl butyral, starch, ethyl cellulose, methyl cellulose, hydroxypropyl cellulose, regenerated cellulose, polyvinyl pyrrolidone, tetrafluoroethylene, polyethylene, polypropylene, ethylene-propylene-diene polymer (EPDM), sulfonated-EPDM, carboxymethyl cellulose (CMC), fluorine rubber, copolymer of propylene and olefin having 2 to 8 carbon atoms, copolymer of (meth)acrylic acid and (meth)acrylic acid alkyl ester, carboxylic acid alkyl ester monomer and ethylenically unsaturated carboxylic acid monomer and various copolymers thereof. In more detail, at least one binder selected from the group consisting of acrylic resins, polyvinyl alcohol, and polyvinyl butyral may be used.

In an embodiment, the binder may be included in an amount of about 0.1 to about 30 wt % based on the solid content weight of the cathode slurry.

Furthermore, the cathode slurry may further include a solvent. The solvent is not particularly limited, but may include an organic solvent and may include an aqueous solvent, and for example, may include at least one selected from the group consisting of water, methyl ethyl ketone, dimethyl ketone, N-methyl-2-pyrrolidone (NMP), ethyl acetate, methoxy propyl acetate, butyl acetate, propyl acetate, isopropyl acetate, glycol acid, butyl ester, butyl glycol, methylalkylpolysiloxane, alkylbenzene, propylene glycol, xylene, monophenylglycol, aralkyl-modified methylalkylpolysiloxane, polyether-modified dimethylpolysiloxane copolymer, polyether-modified dimethylpolysiloxane copolymer, polyacrylate, alkylbenzene, diisobutyl ketone, organic-modified polysiloxane, acetone, methanol, ethanol, isopropanol, n-propanol, butanol, tert-butanol, n-butanol, isobutanol, modified polyacrylate, modified polyurethane and polysiloxane modified polymer.

The solvent may be included so that the solid content is about 5 to about 75 wt % based on the total weight of the cathode slurry. The solvent may also function as a viscosity regulator that controls the viscosity of the cathode slurry.

The cathode current collector may be suitably used in the present disclosure as long as it does not cause a chemical change in the battery and has conductivity, and is not particularly limited thereto, and examples thereof include, but are not limited to, stainless steel, aluminum, nickel, titanium, calcined carbon; aluminum or stainless steel surface-treated with carbon, nickel, titanium, or silver, and aluminum-cadmium alloy. In addition, the cathode current collector may form fine irregularities on the surface of the substrate as described above, and the bonding strength of the cathode active material to the current collector may be strengthened by such irregularities. In addition, the cathode current collector may have various forms, and may be, but is not limited to, a film, a sheet, a foil, a net, a porous body, a foam, or a non-woven fabric.

The cathode current collector may have, but is not limited to, an average thickness of about 3 to about 50 μm.

The method for drying the cathode slurry applied on the cathode current collector is not particularly limited, and for example, drying may be performed by a convection oven or the like.

Thereafter, after applying the electrolyte slurry on the cathode layer, the electrolyte slurry may be dried to manufacture a molded body, and the molded body may be photosintered to form an oxide-based solid electrolyte layer.

In this disclosure, ‘sintering’ refers to a phenomenon in which powder-shaped particles are tightly adhered to each other and solidified by external energy, and for example, may refer to a process in which a molded body of a predetermined shape is manufactured using a slurry containing powder and a binder, and then the powder-shaped particles included in the molded body are adhered to each other through a thermal activation process to form a single mass.

The ‘flash light sintering’ refers to sintering by inducing a heat generation phenomenon caused by a resonance phenomenon between a material's unique wavelength range and a light wavelength range or a heat transfer phenomenon caused by photothermal conversion in which absorbed light is converted into heat, through light, thereby causing a thermal activation reaction in the material.

The electrolyte slurry for manufacturing the molded body may include oxide particles. The oxide particles are not particularly limited, and may be oxide particles containing a lithium element. In detail, the oxide particles may be lithium conductive oxide-based particles. The lithium conductive oxide-based particles are compound particles containing an oxygen element and having conductivity for lithium ions, and may be in a powdered form. In addition to the lithium element, the lithium conductive oxide-based particles may contain at least one or more other metal elements, such as zirconium (Zr), phosphate (PO₄), and titanium (Ti), and may also contain two or more types of oxide particles.

For example, the lithium conductive oxide particles may have a structure of Garnet, NASICON, Perovskite, LiPON, LISICON, or Thio-LISICON (hereinafter also referred to as garnet-type oxide, NASICON-type oxide, perovskite-type oxide, LiPON-type oxide, or Thio-LISICON-type oxide, respectively), and further, but not limited to, may include Li₆La₂CaTa₂O₁₂, Li₆La₂ANb₂O₁₂(where A is Ca or Sr), Li₂Nd₃TeSbO₁₂, Li₃BO_{2.5}N_{0.5}, Li₉SiAlO₈, Li₁₊ₓTi₂₋ₓAlₓSi_{y} (PO₄)_{3-y}(wherein 0×1, 0≤y≤1), LiAlₓZr₂₋ₓ(PO₄)₃ (wherein 0×1, 0≤y≤1), or LiTiₓZr₂₋ₓ(PO₄)₃ (wherein 0≤x≤1, 0≤y≤1).

The garnet-type oxide may be an oxide containing lithium, lanthanum, zirconium, and oxygen, and represented by the chemical formula Li_{7-3x+y-z}AₓLa_{3-y}B_{y}Zr_{2-z}M_{z}O_{12-w}C_{w}. In the chemical formula above, 0≤x≤1, 0≤y≤1, 0≤z≤1, 0≤w≤1, A is a substitution doping element of Li, B is a substitution doping element of La, M is a substitution doping element of Zr, A and B may each independently be at least one selected from the group consisting of aluminum (Al), gallium (Ga), barium (Ba), magnesium (Mg), calcium (Ca), strontium (Sr), potassium (K), cerium (Ce), and rubidium (Rb), M may be at least one selected from the group consisting of molybdenum (Mo), tungsten (W), antimony (Sb), yttrium (Y), niobium (Nb), and tantalum (Ta), and C may be fluorine (F). The garnet-type oxide is not limited thereto, but may be, for example, Li₇La₃Zr₂O₁₂, Li₅La₃Nb₂O₁₂, Li₅La₃Ta₂O₁₂ or Li₆La₂BaTa₂O₁₂.

The NASICON-type oxide may include at least one selected from the group consisting of LAGP (Li₁₊ₓAlₓGe₂₋ₓ(PO₄)₃ (0≤x≤1)), LATP (Li₁₊ₓAlₓTi₂₋ₓ(PO₄)₃ (0≤x≤1)) and LZP(Li₁₊₄xZr₂₋ₓ(PO₄)₃(0≤x≤0.4)).

The perovskite-type oxide may be, for example, lithium lanthanum titanate or lithium lanthanum niobate (LiₓLa_{(1-x)/3}NbO₃) (0≤x≤1).

In more detail, the lithium conductive oxide-based particles may be at least one compound selected from a lithium lanthanum zirconium oxide (LLZO)-based compound, a lithium lanthanum titanate oxide (LLTO)-based compound, a lithium aluminum germanium phosphate (LAGP)-based compound, and a lithium aluminum titanium phosphate (LATP)-based compound.

In more detail, the lithium conductive oxide-based particles may be lithium lanthanum zirconium oxide (LLZO) compounds represented by the chemical formula of Li₇La₃Zr₂O₁₂ and having a garnet structure. When the above-described type of compound, particularly the LLZO compound, is applied as the lithium conductive oxide-based particles, an oxide-based solid electrolyte layer having properties such as excellent ion conductivity, stability with lithium metal, and a wide potential window range may be manufactured.

In theory, all colored materials, except for perfect white that may reflect all light, have properties that absorb light, and in the present disclosure, oxide particles having properties that absorb light in a wavelength range of about 10 to about 1200 nm may be included. When light of the wavelength is irradiated, light other than reflected light and transmitted light is absorbed by the oxide particles and heats up, thereby increasing the temperature of the oxide particles. Flash light sintering may raise the temperature to a high temperature in a short period of time at a heating rate of 10⁴ to 10⁷K/sec.

When light of the wavelength range as above is irradiated one or more times, for example, several hundred times, the temperature of the material increased due to heat generation is maintained, thereby obtaining a sintering effect. In addition, flash light sintering is performed for a short period of time, and thus provides a sintering effect of the oxide particles, suppresses coarsening of the particles due to volume shrinkage, prevents peeling from the substrate due to increased shrinkage, and does not cause heating of the substrate itself, so it does not cause deformation or destruction of the substrate.

The oxide particles may also have an energy band gap of 0.1 to 15 eV in terms of utilizing the energy transfer phenomenon that occurs when electrons in the valence band receive energy and move to the conduction band.

In an embodiment, the oxide particles may have an average particle size of about 0.1 to about 10 μm. If the oxide particles have an average particle size outside the above-described range, sufficient flash light sintering may not occur, thereby deteriorating the conductive properties of the oxide-based solid electrolyte layer.

The electrolyte slurry may further include colored oxide particles. The colored oxide particles theoretically refer to oxide particles having all colors except for perfect white (for example, when the L value according to the CIELAB chromaticity system is 100) that reflects all light. Therefore, ‘colored’ refers to a case in which the L value according to the CIELAB chromaticity system is less than 100.

The colored oxide particles may be those capable of absorbing light energy in a visible light region having a wavelength range of about 400 to about 700 nm. In an embodiment, when the colored-oxide particles are included, light in the region may be absorbed more effectively in the flash light sintering process, so that flash light sintering may be performed more smoothly, and thus, a dense and durable oxide-based solid electrolyte layer may be manufactured.

In addition, by controlling the characteristics of the colored-oxide particles, such as the type and content, during the flash light sintering process, the absorption rate of light absorbed by the molded body may be controlled, and thus, the properties of the oxide-based solid electrolyte layer manufactured by flash light sintering may be freely controlled as needed.

The colored-oxide particles may be included in an amount of about 0.1 to about 10 wt % based on the entire oxide-based particles, and in detail, may be included in an amount of about 0.5 to about 5 wt %, and in more detail, may be included in an amount of about 0.7 to about 2 wt %. When the content of the colored oxide particles is included within the above range, flash light sintering may be performed without affecting oxide particles such as lithium conductive oxide-based particles that are substantially involved in the properties of the oxide-based solid electrolyte layer being manufactured, such as ion conductivity, and the physical properties of the oxide-based solid electrolyte layer, such as durability, may be further improved.

The colored-oxide particles may further improve the light absorption characteristics by using a colored oxide with low brightness, and for example, at least one of oxides of transition metal elements or lanthanum elements may be selected and used, and in detail, oxide particles including at least one selected from the group consisting of vanadium (V), tungsten (W), iron (Fe), bismuth (Bi), zinc (Zn), cobalt (Co), manganese (Mn), copper (Cu), cesium (Ce), arsenic (As), selenium (Se), antimony (Sb), chromium (Cr), nickel (Ni), niobium (Nb), molybdenum (Mo), ruthenium (Ru), rhodium (Rh), palladium (Pd), praseodymium (Pr), neodymium (Nd), terbium (Tb), and erbium (Er), or at least one of the above elements and lithium, may be exemplified.

In addition, the electrolyte slurry may further include an electrolyte binder. The electrolyte binder is not particularly limited and is used to appropriately bind oxide-based particles and improve the adhesion of the electrolyte slurry to the cathode layer, and examples thereof may include polyacrylic resin, ethyl-cellulose, methyl-cellulose, polyvinyl butyral resin, polyvinylidene fluoride, carboxylic acid alkyl esters, and ethylenically unsaturated carboxylic acid monomers. Any one thereof may be used, or two or more thereof may be mixed and used.

In an embodiment, the colored-oxide particles may have an average particle size of about 1 μm or less. If the colored oxide particles have an average particle size of more than about 1 μm, they may not be evenly distributed in the electrolyte slurry, which may result in a decrease in flash light sintering efficiency.

The electrolyte binder is not limited thereto, but may be included in an amount of, for example, about 0.1 to about 30 wt % based on the total weight of the solid content of the electrolyte slurry.

In addition, the electrolyte slurry may further include an electrolyte solvent. The electrolyte solvent is not particularly limited, but may be, for example, a hydrocarbon solvent such as an alcohol, a ketone, an amide, an ester, or an ether. The amount of the electrolyte solvent used is not particularly limited, but may be used such that, for example, the weight ratio of the solid content and the electrolyte solvent is 30 to 40:60 to 70 based on the total weight of the electrolyte slurry.

Meanwhile, the method of applying the electrolyte slurry onto the cathode layer is not particularly limited, and may be applied by a method such as bar coating, casting, or spraying. The electrolyte slurry may be applied onto the cathode layer with a coating weight of about 50 to about 5000 mg/cm².

In addition, the method of drying the electrolyte slurry applied on the cathode layer is not particularly limited, and may be performed, for example, by a convection oven or the like.

The drying may be performed at about 50 to about 200° C., and in detail, may be performed at about 80 to about 120° C. In addition, the drying may be performed for about 0.5 to about 5 hours, and in detail, may be performed for about 1 to about 3 hours.

The molded body may be manufactured with various thicknesses depending on the viscosity of the electrolyte slurry and the oxide particle size, and for example, a molded body having a thickness of about 10 to about 100 μm may be manufactured. Furthermore, the molded body may be manufactured with a thickness of about 10 μm or less, or may be manufactured with a thickness of about 100 μm or more. Depending on the light absorption rate, a molded body capable of obtaining an oxide-based solid electrolyte layer having a thickness of about 300 μm or less may be manufactured.

Meanwhile, in the operation of forming the oxide-based solid electrolyte layer by flash light sintering the molded body, a mixed layer including the cathode active material and the oxide particles may be formed together between the cathode layer and the oxide-based solid electrolyte layer.

In the mixed layer, the cathode active material constituting the cathode layer and the oxide particles constituting the oxide-based solid electrolyte layer may be randomly mixed within a certain thickness range from the surface of the oxide-based solid electrolyte layer toward the cathodecurrent collector, and the cathode active material and the oxide particles may coexist within the thickness range to form a boundary between the cathode layer and the oxide-based solid electrolyte layer.

In detail, the cathode layer including the cathode active material, a conductive material, a binder, and the like may have pores depending on the density of the mixture, or the like. When the electrolyte slurry is applied on the cathode layer, the electrolyte slurry is impregnated into the pores of the cathode layer, and then, during flash light sintering, the electrolyte particles impregnated into the pores of the cathode layer are photosintered, so that the mixed layer including the cathode active material and the oxide particles may be formed.

Therefore, according to an embodiment, a cathode-solid electrolyte multilayer structure is provided, including a cathode layer including a cathode active material, an oxide-based solid electrolyte layer formed on the cathode layer and including oxide particles, and a mixed layer formed between the cathode layer and the oxide-based solid electrolyte layer and including the cathode active material and the oxide particles.

In addition, according to another embodiment, an all-solid lithium secondary battery is provided, which includes a cathode including a cathode active material-containing cathode layer, an oxide-based solid electrolyte layer formed on the cathode and including oxide particles, a mixed layer formed between the cathode and the oxide-based solid electrolyte layer and including the cathode active material and the oxide particles, and an anode formed on the oxide-based solid electrolyte.

The cathode active material and the oxide particles may be in contact with each other in the mixed layer. In example embodiments, the cathode active material and the oxide particles may be in point contact or surface contact with each other in the mixed layer.

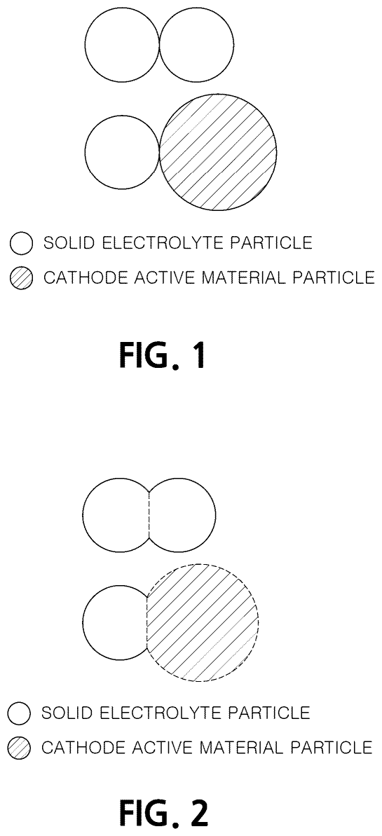

The point contact is a simple contact between the cathode active material particles and the oxide particles at an interface between the particles, and a state of point contact between the two particles is schematically illustrated in FIG. 1. FIG. 1 illustrates an example of two contacting particles, for example, two oxide particles or an oxide particle and a cathode active material particle, which are perfect spheres. As illustrated in FIG. 1, the point contact may be said to be a state in which they are physically in contact, but are not physically or chemically bonded or combined.

The surface contact is a state in which the cathode active material particle and the oxide particle form a surface at the interface between the particles, and the state of surface contact between the two particles is schematically illustrated in FIG. 2. FIG. 2 illustrates an example of two contacting particles, for example, two oxide particles or an oxide particle and a cathode active material particle, which are perfect spheres. As illustrated in FIG. 2, the surface contact may be said to be a state in which the two particles are partially softened by sintering or the like, so that the contact area between the two particles in contact increases, and the two particles are bonded by solidification and may behave as a single mass.

In particular, when the cathode active material and the oxide particles are in surface contact with each other, the contact area between the cathode active material and the oxide particles increases, so that the area provided as a movement path for lithium ions to move within the mixed layer increases, and thus the resistance of the mixed layer may decrease. Therefore, the interfacial resistance between the mixed layer and the cathode layer may decrease.

In addition, the mixed layer may further include the colored-oxide particles. The colored-oxide particles may be evenly distributed in the mixed layer, so that the cathode active material and the oxide particles may facilitate point contact or surface contact with each other in the mixed layer.

Accordingly, the interfacial resistance between the mixed layer and the cathode layer may be further decreased.

In an embodiment, the mixed layer may have a thickness of about 0.1 to about 10 μm. If the mixed layer has a thickness of less than about 0.1 μm, the binder, conductive material, or the like included in the cathode layer may be damaged during the flash light sintering process, which may result in deterioration of cell performance. If the mixed layer has a thickness of more than about 10 μm, the molded body may not be sufficiently photosintered during the flash light sintering process, which may result in the oxide-based solid electrolyte layer not being properly formed.

Meanwhile, in an embodiment, the cathode layer may have a thickness of about 1 to about 100 μm. If the cathode layer has a thickness of less than about 1 μm, the capacity of the cathode layer may be small, which may result in deterioration of cell characteristics. If the cathode layer has a thickness of more than about 100 μm, the cathode layer may excessively absorb thermal energy generated during flash light sintering, which may result in the oxide-based solid electrolyte layer and the mixed layer not being sufficiently photosintered, which may result in the oxide-based solid electrolyte layer and the mixed layer not being properly formed.

In an embodiment, the sum of the thicknesses of the mixed layer and the cathode layer may be about 1.1 to about 110 μm. If the sum of the thicknesses of the mixed layer and the cathode layer is less than about 1.1 μm, the mixed layer and the cathode layer may absorb excessive energy during flash light sintering, which may cause damage to the mixed layer and the cathode layer. If the sum of the thicknesses of the mixed layer and the cathode layer is greater than about 110 μm, energy loss may occur during flash light sintering, which may prevent the oxide-based solid electrolyte layer from being sufficiently photosintered.

In an embodiment, the thickness ratio of the mixed layer and the cathode layer may be about 1:100 to about 1:10. If the thickness ratio of the mixed layer and the cathode layer is within the above-described range, the contact resistance between the oxide-based solid electrolyte layer and the cathode layer may be reduced. If the thickness ratio of the mixed layer and the cathode layer is less than about 1:100, the mixed layer may not be sufficiently formed, and thus the contact resistance between the oxide-based solid electrolyte layer and the cathode layer may increase. If the thickness ratio of the mixed layer and the cathode layer is greater than about 1:10, a large amount of the electrolyte slurry may be impregnated into the cathode layer, and thus the oxide-based solid electrolyte layer may not be uniformly formed.

Thereby, the manufacture of the cathode-solid electrolyte multilayer structure may be completed.

If the compact formed on the cathode layer is thermally sintered to form the oxide-based solid electrolyte layer, a high temperature condition of about 1000° C. or higher is required to thermally sinter the compact, which may cause thermal decomposition of carbon components such as binders and conductive materials included in the cathode layer and melting of the current collector. In addition, due to thermal sintering that is performed for a long period of time such as 1 to 24 hours, loss of material may occur due to volatilization of volatile materials such as lithium during thermal sintering. In addition, since the contact area between oxide particles excessively increases, particle coarsening and volume shrinkage may occur, which may cause the oxide-based solid electrolyte layer to peel off and/or crack from the cathode layer. In addition, it may be difficult to form a large-area oxide-based solid electrolyte due to thermal deformation caused by thermal stress. Furthermore, thermal damage may occur on the upper portion of the cathode layer due to thermal sintering that is performed at a high temperature for a long period of time. Due to these problems, the interfacial resistance between the cathode layer and the oxide-based solid electrolyte layer may increase.

However, in example embodiments, the oxide-based solid electrolyte layer may be formed by flash light sintering the molded body formed on the cathode layer. The flash light sintering is performed by repeatedly irradiating light in the wavelength range of 10 to 1200 nm hundreds of times, so that the temperature of the material increased due to heat generation is maintained to obtain a sintering effect. In addition, the flash light sintering is performed for a short period of time, so that particle coarsening and volume shrinkage are prevented, thereby preventing the oxide-based solid electrolyte layer from being peeled off and/or cracked from the cathode layer, thereby forming a large area of the oxide-based solid electrolyte. In addition, since the flash light sintering is performed for a short period of time, thermal damage may not occur on the upper portion of the cathode layer.

In addition, as described above, a mixed layer may be formed between the cathode layer and the oxide-based solid electrolyte layer by the flash light sintering process. In the mixed layer, the cathode active material and the oxide particles may contact each other. Accordingly, the interfacial resistance between the mixed layer and the cathode layer may be reduced.

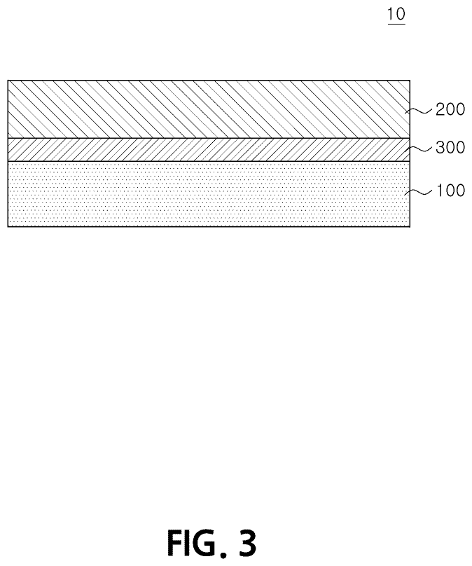

Hereinafter, a cathode-solid electrolyte multilayer structure manufactured by the method of manufacturing a cathode-solid electrolyte multilayer structure will be described with reference to FIG. 3. The description of the cathode-solid electrolyte multilayer structure that overlaps with the description of the method of manufacturing the cathode-solid electrolyte multilayer structure will be omitted.

FIG. 3 is a drawing illustrating a cathode-solid electrolyte multilayer structure according to an embodiment.

Referring to FIG. 3, the cathode-solid electrolyte multilayer structure 10 may include the cathode layer 100 including the cathode active material, the oxide-based solid electrolyte layer 200 formed above the cathode layer 100 and including the oxide particles, and the mixed layer 300 formed between the cathode layer 100 and the oxide-based solid electrolyte layer 200 and including the cathode active material and the oxide particles contacting each other.

Meanwhile, the cathode-solid electrolyte multilayer structure may be applied to an all-solid lithium secondary battery. At this time, the cathode layer may perform the role of a cathode of the all-solid lithium secondary battery, and the oxide-based solid electrolyte layer may perform the role of an oxide-based solid electrolyte of the all-solid lithium secondary battery. Accordingly, hereinafter, the cathode layer may also be referred to as a cathode, and the oxide-based solid electrolyte layer may also be referred to as an oxide-based solid electrolyte.

As described above, a mixed layer is formed between the cathode and the oxide-based solid electrolyte layer, and the cathode active material and the oxide particles may contact each other in the mixed layer. Accordingly, the movement path of lithium ions in the mixed layer increases, and the resistance of the mixed layer may be reduced. As a result, the interfacial resistance between the mixed layer and the cathode is reduced, and further, the stability of the all-solid lithium secondary battery may be improved.

As described above, the cathode-solid electrolyte multilayer structure may be applied to an all-solid lithium secondary battery.

The all-solid lithium secondary battery may include the cathode including the cathode active material, the oxide-based solid electrolyte formed on the cathode and including the oxide particles, the mixed layer formed between the cathode and the oxide-based solid electrolyte and including the cathode active material and the oxide particles, and the anode formed on the oxide-based solid electrolyte.

The anode may include an anode current collector and an anode mixture layer formed on at least one surface of the anode current collector.

The components of the anode current collector are not particularly limited, and a plate or foil made of indium (In), copper (Cu), magnesium (Mg), stainless steel, titanium (Ti), iron (Fe), cobalt (Co), nickel (Ni), zinc (Zn), aluminum (Al), germanium (Ge), lithium (Li), or alloys thereof may be used.

The anode mixture layer may include a carbon-based active material such as artificial graphite or natural graphite, a silicon-based active material such as silicon oxide (SiOx; 0≤x≤2), a Si—C composite, or pure Si, and a metal such as lithium metal.

The anode mixture layer may further include an anode binder. The anode binder may include, for example, one, two, or more of styrene butadiene rubber (SBR), polytetrafluoroethylene, polyvinylidene fluoride, polyethylene, vinylidene fluoride/hexafluoropropylene copolymer, polyacrylonitrile, polymethyl methacrylate, and the like.

The anode mixture layer may further include an anode conductive material. The anode conductive material may include, for example, one, two, or more of graphite such as natural graphite or artificial graphite, a carbon-based material such as carbon black, acetylene black, Ketjen black, channel black, furnace black, lamp black, thermal black, carbon fiber, carbon nanotube (CNT), or the like, metal powder or metal fiber such as copper, nickel, aluminum, silver, or the like, conductive whiskers such as zinc oxide or potassium titanate, conductive metal oxides such as titanium oxide, or the like, or a conductive polymer such as polyphenylene derivatives.

The all-solid lithium secondary battery may be manufactured by manufacturing the cathode, the oxide-based solid electrolyte, and the mixed layer by the method of manufacturing a cathode-solid electrolyte multilayer structure, applying a slurry containing an anode active material on an anode current collector on the oxide-based solid electrolyte, and then drying and rolling to form an anode.

Meanwhile, the all-solid lithium secondary battery may not include an anode mixture layer (hereinafter, also referred to as an anode-free secondary battery), and for example, may be a battery that does not form an anode mixture layer containing an anode active material on an anode current collector during the battery assembly process. When an anode-free lithium secondary battery is initially charged or first charged, the main cathode active material and the sacrificial cathode active material are delithiated, and lithium ions generated from the cathode active material are reduced on the anode current collector to form a lithium metal layer or a lithium layer of a solid lithium layer.

In an embodiment, the all-solid lithium secondary battery may include a lithium metal anode.

### EXAMPLES

Hereinafter, the present disclosure will be described in more detail with reference to examples. The following examples are intended to illustrate an example of the present disclosure and are not intended to limit the present disclosure.

### Example 1

A cathode slurry was prepared by mixing NCM622 (Li(Ni_{1.6}Co_{0.2}Mn_{0.2}) O₂) as a cathode active material, Super-P as a cathode conductive material, and PVdF as a cathode binder with NMP as a solvent. At this time, the cathode slurry was prepared to include 95 wt % of the cathode active material, 2.5 wt % of the cathode conductive material, and 2.5 wt % of the cathode binder based on the total solid weight of the cathode slurry. Afterwards, the cathode slurry was applied on the aluminum (Al) foil, which is a cathode current collector, and then dried at 80° C. to form a cathode mixture layer, thereby manufacturing a cathode layer with a thickness of 30 μm.

Afterwards, the oxide-based electrolyte, lithium lanthanum zirconium oxide (LLZO; Li₇La₃Zr₂O₁₂) particles, colored oxide particles (Fe₂O₃), and PVB as a binder were mixed with the solvent, toluene/iPA to manufacture the electrolyte slurry. At this time, the electrolyte slurry was manufactured to contain 97 wt % of the electrolyte, 2 wt % of the binder, and 1 wt % of the colored-oxide particles based on the total solid weight of the electrolyte slurry.

The electrolyte slurry was cast on the cathode layer with a coating weight of 2000 mg/cm², and then dried in a convection oven at 100° C. for 2 hours to produce an oxide-based molded body having a thickness of 50 μm.

The cathode layer and the oxide-based molded body were loaded into a flash light sintering device (Novacentrix PulseForge Invent), and flash light sintering was performed under the flash light sintering conditions illustrated in Table 1 below to produce an oxide-based solid electrolyte on the cathode layer, thereby producing the cathode-solid electrolyte multilayer structure of Example 1.

TABLE 1
Flash Light Sintering Conditions

| Conditions | Voltage | 300 | V |
|---|---|---|---|
| Constituting | Light Irradiation Time per | 3000 | μs |
| One Pulse | Pulse (On-time) | | |
| | Pulse Interval (Off-time) | 60% | |
| | Number of Cycles | 10 | |
| Operating | Fire rate | 25 | Hz |

| | | |
|---|---|---|
| Conditions | Number of Repetitions | 250 |

| | | |
|---|---|---|
| Energy of Irradiated Light | 75 | J/s · cm² |

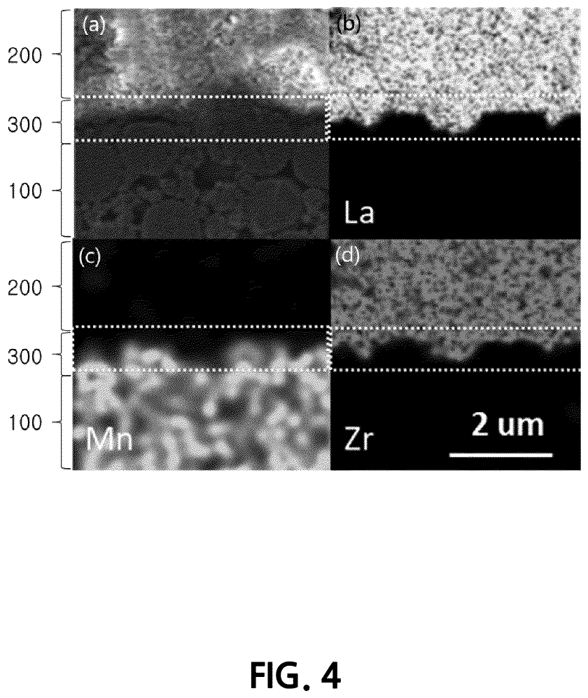

The cross-section of the fabricated cathode-oxide-based solid electrolyte multilayer structure was photographed by SEM, and the results are illustrated in part (a) of FIG. 4. Furthermore, the elemental distributions of La, Mn, and Zr were photographed by Energy Dispersive X-ray Spectroscopy (EDS), and the photographs are illustrated in part (b), (c) and (d) of FIG. 4, respectively. As can be seen from FIG. 4, the fabricated cathode-solid electrolyte multilayer structure has a cathode layer 100, an oxide-based solid electrolyte layer 200, and a mixed layer 300 formed at the interface between the cathode layer and the oxide-based solid electrolyte layer, in which cathode active material and oxide-based solid electrolyte particles are mixed. It was found that the mixed layer was formed when the solid electrolyte particles penetrated into the pores of the cathode layer surface as the oxide-based solid electrolyte slurry was applied to the surface of the cathode layer.

### Comparative Example 1

1 g of lithium lanthanum zirconium oxide (LLZO; Li₇La₃Zr₂O₁₂) powder, which is an oxide-based electrolyte, was formed into a pellet using a uniaxial press, placed in an aluminum crucible, and thermally sintered in an electric furnace at 1200° C. for 5 hours. The sintered body manufactured by thermal sintering was polished to a thickness of 200 μm using a specimen polisher to manufacture an electrolyte sintered body, and then the cathode mixture layer manufactured in the same manner as in Example 1 and the sintered body were placed in a pressurizing jig and physically contacted with a pressure of 0.1 MPa to manufacture a cathode-solid electrolyte multilayer structure.

### Interfacial Resistance Measurement

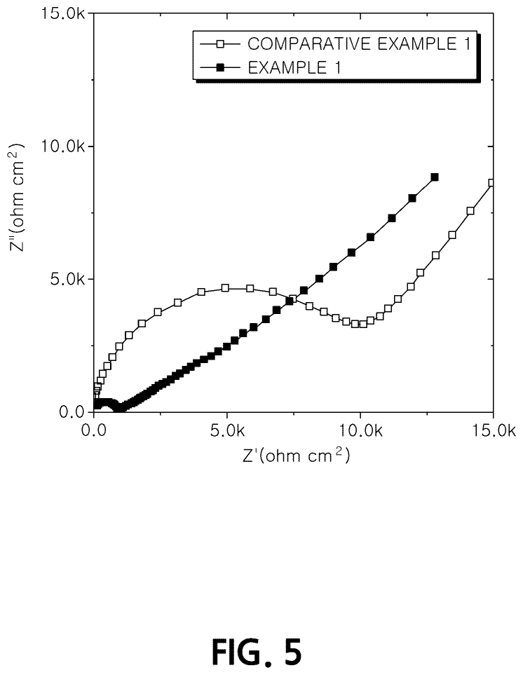

After depositing Au electrodes on both surfaces of the electrolyte side of the cathode-solid electrolyte multilayer structure manufactured in the same manner as in Example 1 and Comparative Example 1, AC impedance measurements were performed to measure the interfacial resistance between the cathode layer and the electrolyte layer, and the results are illustrated in Table 2 and FIG. 5.

TABLE 2

| | Contact Resistance (Ω · cm²) |
|---|---|
| Example 1 | 949 |
| Comparative Example 1 | 9.82 × 10³ |

The contact resistance in Table 2 above is the contact resistance value, which is the x-axis value at the point where the semicircle shape ends in FIG. 5. As can be seen from Table 2, the cathode-solid electrolyte multilayer structure obtained in Example 1 has a significantly lower contact resistance value than the cathode-solid electrolyte multilayer structure obtained in Comparative Example 1.

In addition, FIG. 5 is the result of the AC impedance measurement in which the AC impedance value is expressed as the real axis (x-axis) and the imaginary axis (y-axis). The x-axis value at the point where the semicircle shape ends in the graph of FIG. 5 corresponds to the contact resistance value, and it can be seen that Example 1 has a significantly reduced contact resistance value compared to Comparative Example 1.

As described above, the reason why the cathode-solid electrolyte multilayer structure of Example 1 has a lower contact resistance value than the cathode-solid electrolyte multilayer structure of Comparative Example 1 is that the cathode active material and the solid electrolyte are mixed at the interface of the cathode layer and the solid electrolyte layer to form a mixed layer, and also that the movement path of lithium ions is increased by forming a surface contact between the cathode active material and the solid electrolyte during the sintering process.

As set forth above, in a method of manufacturing a cathode-solid electrolyte multilayer structure according to example embodiments, an oxide-based solid electrolyte layer may be formed by flash light sintering a molded body including oxide particles formed on a cathode layer. The flash light sintering is performed by repeatedly irradiating light in a wavelength range of 10 to 1,200 nm hundreds of times, so that the temperature of the material increased due to heat generation is maintained, thereby obtaining a sintering effect. In addition, the flash light sintering is performed for a short period of time, so that particle coarsening and volume shrinkage are prevented, thereby preventing the oxide-based solid electrolyte layer from being peeled off and/or cracked from the cathode layer, and thus forming a large-area oxide-based solid electrolyte. In addition, since the flash light sintering is performed for a short period of time, thermal damage may not occur on an upper portion of the cathode layer.

In addition, the cathode-solid electrolyte multilayer structure manufactured by the method of manufacturing a cathode-solid electrolyte multilayer structure is formed between the cathode layer and the oxide-based solid electrolyte layer, and includes the cathode active material and the oxide particles, and the cathode active material and the oxide particles may contact each other in the mixed layer. As the cathode active material and the oxide particles contact each other in the mixed layer, the movement path of lithium ions in the mixed layer increases, so that the resistance of the mixed layer may decrease. As a result, the interfacial resistance between the mixed layer and the cathode layer decreases, and further, the stability of the all-solid lithium secondary battery may be improved.

Although the embodiments have been described in detail above, they are merely illustrative, and those skilled in the art will understand that various modifications and equivalent other embodiments are possible. Therefore, the true technical protection scope of the present disclosure should be determined by the technical idea of the appended claims.

The specific implementations described in the embodiments are example embodiments and do not limit the scope of the embodiments in any way. In addition, if there is no detailed mention such as “essential,” “important,” or the like, it may not be an element that is absolutely necessary for the application of the present disclosure.

The use of the term “the” and similar referential terms in the specification of the embodiments (especially in the claims) may be in both the singular and plural. In addition, when a range is described in the embodiments, it is intended to include disclosure of individual values within the range (unless otherwise stated), and is equivalent to describing each individual value constituting the range in the detailed description. Finally, unless the order of the steps constituting the method according to the embodiments is explicitly stated or stated to the contrary, the steps may be performed in any suitable order. The embodiments are not necessarily limited by the order in which the steps are described. The use of all examples or illustrative terms (for example, the like, etc.) in the embodiments is merely intended to describe the embodiments in detail, and the scope of the embodiments is not limited by the examples or illustrative terms unless otherwise defined by the claims. Furthermore, those skilled in the art will recognize that various modifications, combinations, and variations may be made within the scope of the appended claims or their equivalents, depending on design conditions and factors.

Only specific examples of implementations of certain embodiments are described. Variations, improvements and enhancements of the disclosed embodiments and other embodiments may be made based on the disclosure of this patent document.

What is claimed is:

1. A cathode-solid electrolyte multilayer structure comprising:
a cathode layer including a cathode active material;
an oxide-based solid electrolyte layer formed on the cathode layer and including oxide particles; and
a mixed layer formed between the cathode layer and the oxide-based solid electrolyte layer and including the cathode active material and the oxide particles,
wherein the cathode active material and the oxide particles are in contact with each other in the mixed layer.

2. The cathode-solid electrolyte multilayer structure of claim 1, wherein the cathode active material and the oxide particles are in surface contact with each other in the mixed layer.

3. The cathode-solid electrolyte multilayer structure of claim 1, wherein the mixed layer has a thickness of 0.1 to 10 μm.

4. The cathode-solid electrolyte multilayer structure of claim 1, wherein the cathode layer has a thickness of 1 to 100 μm.

5. The cathode-solid electrolyte multilayer structure of claim 1, wherein a sum of thicknesses of the mixed layer and the cathode layer is 1.1 to 110 μm.

6. The cathode-solid electrolyte multilayer structure of claim 1, wherein a thickness ratio of the mixed layer and the cathode layer is 1:100 to 1:10.

7. The cathode-solid electrolyte multilayer structure of claim 1, wherein the oxide particles have an average particle size of 0.1 to 10 μm.

8. The cathode-solid electrolyte multilayer structure of claim 1, wherein the cathode active material has an average particle size of 0.1 to 20 μm.

9. The cathode-solid electrolyte multilayer structure of claim 1, wherein the mixed layer further includes colored-oxide particles.

10. The cathode-solid electrolyte multilayer structure of claim 9, wherein the colored-oxide particles have an average particle size of 1 μm or less.

11. The cathode-solid electrolyte multilayer structure of claim 9, wherein the colored-oxide particles absorb light energy in a visible light range.

12. An all-solid lithium secondary battery comprising:
a cathode including a cathode active material-containing cathode layer;
an oxide-based solid electrolyte layer formed on the cathode and including oxide particles;
a mixed layer formed between the cathode and the oxide-based solid electrolyte layer and including the cathode active material and the oxide particles; and
an anode formed on the oxide-based solid electrolyte layer,
wherein the cathode active material and the oxide particles are in contact with each other in the mixed layer.

13. The all-solid lithium secondary battery of claim 12, wherein the cathode active material and the oxide particles are in surface contact with each other in the mixed layer.

14. The all-solid lithium secondary battery of claim 12, wherein the mixed layer has a thickness of 0.1 to 10 μm.

15. The all-solid lithium secondary battery of claim 12, wherein the cathode layer has a thickness of 1 to 100 μm.

16. The all-solid lithium secondary battery of claim 12, wherein a sum of thicknesses of the mixed layer and the cathode is 1.1 to 110 μm.

17. The all-solid lithium secondary battery of claim 12, wherein the mixed layer further includes colored-oxide particles.

18. The all-solid lithium secondary battery of claim 17, wherein the colored-oxide particles have an average particle size of 1 μm or less.

19. A method of manufacturing a cathode-solid electrolyte multilayer structure, comprising:
manufacturing a cathode layer including a cathode active material;
applying an electrolyte slurry including oxide particles onto the cathode layer and then drying the electrolyte slurry, and manufacturing a molded body; and
flash light sintering the molded body and forming an oxide-based solid electrolyte layer,
wherein in the flash light sintering the molded body and forming the oxide-based solid electrolyte layer, a mixed layer including the cathode active material and the oxide particles in contact with each other is formed between the cathode layer and the oxide-based solid electrolyte layer.

20. The method of claim 19, wherein the electrolyte slurry further includes colored-oxide particles,
wherein in the flash light sintering the molded body and forming the oxide-based solid electrolyte layer, the colored-oxide particles are included in the mixed layer.
